(19) United States
(12) Patent Application Publication
(10) Pub. No.: US 2021/0065079 A1
(43) Pub. Date: Mar. 4, 2021

(54) METHODS AND SYSTEMS FOR IMPLEMENTING RISK ASSESSMENT MODELS

(71) Applicant: Capital One Services, LLC, McLean, VA (US)

(72) Inventors: David WARREN, Richmond, VA (US); Marc LYONS, Glen Allen, VA (US); Magdalena CASTANEDA, Herndon, VA (US); Jerry WAGNER, Chesterfield, VA (US)

(73) Assignee: Capital One Services, LLC, McLean, VA (US)

(21) Appl. No.: 16/550,811

(22) Filed: Aug. 26, 2019

(51) Int. Cl. G06Q 10/06; G06F 17/16

(52) U.S. Cl. CPC G06Q 10/0635; G06F 17/16; G06Q 10/0637

(57) ABSTRACT

A computer-implemented method for assessing automation may include receiving risk factor data from a user. The risk factor data may correspond to one or more risk factors, as applied to an automation opportunity, wherein each risk factor has an associated risk inquiry and a factor weight. A risk score may be generated for each of the one or more risk factors, based on the risk factor data and a scoring matrix. A risk grade for the automation opportunity may be calculated based on the risk score for each of the one or more risk factors. Performance data related to the automation opportunity may be recorded and may be compared to the risk grade. Based on the comparison of the performance data to the risk grade, one or more risk factors, one or more factor weights, a scoring matrix, or a combination thereof, may be adjusted.

### TECHNICAL FIELD

Various embodiments of the present disclosure relate generally to systems and methods for implementing risk assessment models. More specifically, embodiments of the present disclosure relate to methods and systems for determining risk related to automation opportunities.

### BACKGROUND

Automation is rapidly being implemented in every business sector and industry. Automation may take the form of, for example, programs, applications, scripts, or systems implementing processes. Automation creates a unique, shifting pattern of risk, different from other technological innovations. Characterizing the risks associated with automation is problematic as the landscape of potential risk changes almost constantly.

Without accurate assessment and forecasting of risk involved, informed decisions regarding implementation, maintenance, and/or elimination of automation, cannot be made. Lack of predictability regarding automation may result in one or more actors failing to realize an automation opportunity.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, non-transitory computer readable media, systems, and methods are disclosed for assessing automation opportunities. Each of the examples disclosed herein may include one or more of the features described in connection with any of the other disclosed examples.

In one example, a computer-implemented method for assessing automation may include receiving risk factor data from a user. The risk factor data may correspond to one or more risk factors, as applied to an automation opportunity, wherein each risk factor has an associated risk inquiry and a factor weight. A risk score may be generated for each of the one or more risk factors, based on the risk factor data and a scoring matrix. A risk grade for the automation opportunity may be calculated based on the risk score for each of the one or more risk factors. Performance data related to the automation opportunity may be recorded and may be compared to the risk grade. Based on the comparison of the performance data to the risk grade, one or more risk factors, one or more factor weights, a scoring matrix, or a combination thereof, may be adjusted.

According to another aspect of the disclosure, a computer system for assessing automation may comprise a memory storing instructions and one or more processors configured to execute the instructions to perform operations. The operations may include transmitting one or more risk inquiries to a user. The operations may also include receiving a response to the one or more risk inquiries from the user, the response including risk factor data. The risk factor data may correspond to one or more risk factors, as applied to an automation opportunity, wherein each risk factor has a factor weight. The operations may also include generating a risk score for each of the one or more risk factors, based on the risk factor data and a scoring matrix. A plurality of category scores may be determined, based on the risk scores and the factor weights. Based on the plurality of category scores, a risk grade for the automation opportunity may be determined.

According to some exemplary aspects of the present disclosure, a non-transitory computer-readable medium stores instructions that, when executed by one or more processors of a computer system, cause the one or more processors to perform operations. The operations may include transmitting one or more risk inquiries to a user device. The operations may include receiving a response to the one or more risk inquiries from the user device, wherein the response includes risk factor data. The risk factor data may correspond to one or more risk factors, wherein each risk factor has a factor weight. The operations may also include generating a risk score for each of the plurality of risk factors, based on the risk factor data and a scoring matrix. The operations may also include, based on the risk scores and the factor weights, calculating a risk grade. Performance data related to the automation opportunity may be recorded and may be compared to the risk grade. Based on the comparison of the performance data to the risk grade, one or more risk factors, one or more factor weights, a scoring matrix, or a combination thereof, may be adjusted. The risk grade may be transmitted to the user device.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a block diagram of an exemplary architecture including a risk assessment module, according to one or more embodiments;

FIG. 2 is a block diagram of an exemplary risk assessment module, according to one or more embodiments;

FIG. 3 depicts a graphical representation of a risk associated with an automation opportunity, as determined by a risk assessment module, according to one or more embodiments;

FIG. 4 depicts a flow chart of an example method, according to one or more embodiments; and

FIG. 5 depicts an exemplary computer device or system, in which embodiments of the present disclosure, or portions thereof, may be implemented.

### DETAILED DESCRIPTION

Various embodiments of the present disclosure generally relate to determining risk associated with an automation opportunity.

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value. Additionally, in this disclosure, the term “computer system” generally encompasses any device or combination of devices, each device having at least one processor that executes instructions from a memory medium. Additionally, a computer system may be included as a part of another computer system.

Generally, innovators or other actors may recognize an opportunity to deploy and/or implement an automation. The opportunity to implement an automation (e.g., an automation opportunity) may be assessed for return-on-investment and potential risks. Automation opportunities with a positive reward to risk ratio may be implemented. According to one or more embodiments, a computer-implemented method for assessing automation may include receiving risk factor data from a user. The risk factor data may correspond to one or more risk factors, as applied to an automation opportunity. Each risk factor may have an associated risk inquiry and a factor weight. Computer-implemented methods for assessing automation may also include generating a risk score for each of the one or more risk factors. Each risk score may be generated on the basis of risk factor data and a scoring matrix. A risk grade for the automation opportunity may be calculated based on the risk score for each of the one or more risk factors. Methods of the present disclosure may also include recording performance data related to the automation opportunity and/or comparing the performance data to the risk grade.

Based on the comparison of the performance data to the risk grade, one or more actions may be taken. In some embodiments, as described in greater detail below, upon a determination that the performance data indicates that a risk grade was inappropriately associated with an automation opportunity, one or more components of the risk grade may be adjusted. For example, one or more risk factors may be adjusted, one or more factor weights may be adjusted, one or more scoring matrices may be adjusted, or a combination thereof

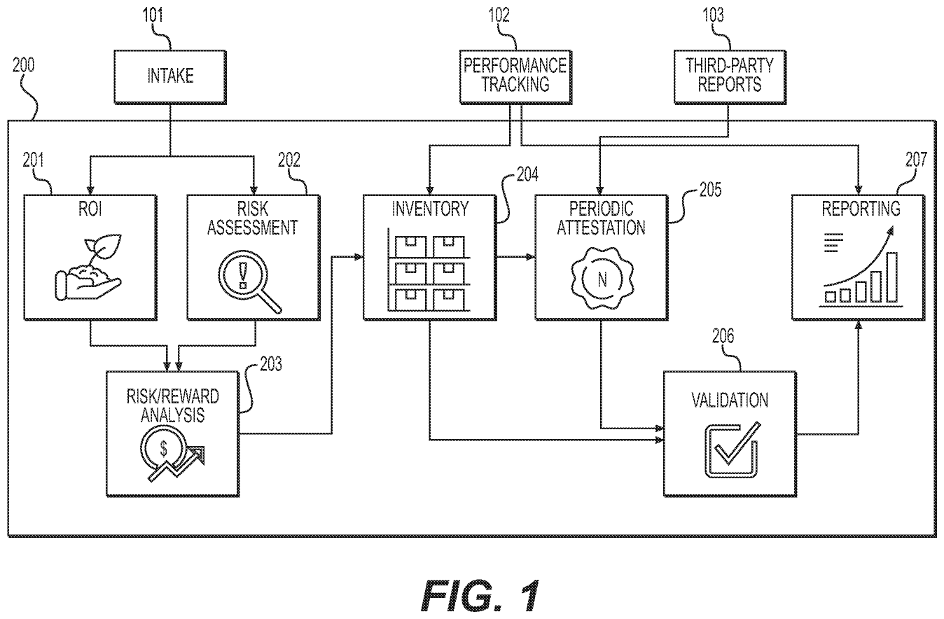

Referring to FIG. 1, one or more computer-implemented methods described herein may be performed by a risk assessment module 202. The risk assessment module 202 may be a component of a larger automation assessment system 200. Access to system 200 may be restricted to users with requisite permissions (e.g., system administrators, information security professionals, etc.). System 200 may receive automation opportunities from an intake system 101, as described in further detail below. Additionally, system 200 may receive performance logs (e.g., from performance tracking system 102) and/or third-party reports 103 related to one or more automation opportunities from one or more other systems, and/or from intake system 101. For example, intake system 101 may receive performance logs (e.g., from performance tracking system 102) and/or third-party reports 103, and then relay that information to system 200 along with one or more automation opportunities.

In some embodiments, after automation assessment system 200 receives an automation opportunity from intake system 101, the automation opportunity may be communicated to a Return on Investment (ROI) module 201 and/or risk assessment module 202. ROI module 201 may determine, calculate, and/or estimate a ROI for the automation opportunity. The ROI may include data related to value added, value returned, value created, and/or value lost due to, or caused by, the automation opportunity. ROI module 201 may communicate the ROI to risk/reward analysis module 203. As described in greater detail below, risk assessment module 202 may calculate, determine, and/or assign a risk score to the automation opportunity. In some embodiments, risk assessment module 202 may communicate the risk score to risk/reward analysis module 203. In some embodiments, the automation opportunity is communicated to ROI module 201, then transmitted to risk assessment module 202, before being communicated to risk/reward analysis module 203. In other embodiments, the automation opportunity is communicated to risk assessment module 202, then transmitted to ROI module 201, before being communicated to risk/reward analysis module 203.

Risk/reward analysis module 203 may process information related to ROI and the risk score. Risk/reward analysis module 203 may make a determination as to whether to approve an automation opportunity. Risk/reward analysis module 203 may also use input(s) from a user in the determination to approve an automation opportunity. In some embodiments, users of system 200 may not be able to implement an automation opportunity until approval is granted by risk/reward assessment module 203. After approval is granted by risk/reward analysis module 203, the automation opportunity may be added to an inventory 204. In some embodiments, only after an automation opportunity is implemented, may it be added to inventory 204.

System 200 may receive performance data from a performance tracking system 102 relating to one or more previously implemented automation opportunities stored in inventory 204. The performance data may include information related to risks presented, risks mitigated, value added, value returned, value created, and/or value lost due to, or caused by, the one or more previously implemented automation opportunities. The performance data may be communicated to inventory 204 and/or reporting module 207, described below. Inventory 204 may also include performance data associated with each automation opportunity of inventory 204.

Inventory 204 data (e.g., data related to one or more automation opportunities and/or performance data associated with those opportunities) may be transmitted to periodic attestation module 205 and/or validation module 206. In some embodiments, system 200, e.g., periodic attestation module 205, may receive performance data from third-party reports 103. At time intervals, either regular or irregular, periodic attestation module 205 may use data received from inventory 204 related to one or more automation opportunities and performance data related to the one or more automation opportunities, and optionally, performance data received from third-party reports 103, to produce third-party validation data. In some embodiments, periodic attestation module 205 may compare performance data from third-party reports 103 with performance data from performance tracking system 102 (e.g., performance data communicated via inventory 204), to, for example, produce third-party validation data. The third-party validation data may include comparisons between performance data from third-party reports 103 and performance data from performance tracking system 102.

In some embodiments, validation module 206 receives third-party validation data from periodic attestation module 205. Similar to periodic attestation module 205, validation module 206 may compare performance data from third-party reports 103 with performance data received from performance tracking system 102, such as, for example, in the form of validation data received from periodic attestation module 205. Validation module 206 may also compare a risk score associated with an automation opportunity (e.g., a risk score received from inventory 204) with performance data associated with the automation opportunity. Based on the comparison, one or more adjustments may be made. For example, if the performance data indicates that risks presented, risks mitigated, value added, value returned, value created, and/or value lost is different from that determined by ROI module 201 and/or risk assessment module 202, one or more adjustments may be made. As described in greater detail below, these adjustments may include adjusting one or more risk factors, adjusting one or more factor weights, adjusting a scoring matrix, or a combination thereof. Validation module 206 may transmit data relating to the comparison of risk score and performance data associated with an automation opportunity to reporting module 207.

System 200 may further produce reports and communicate the reports to one or more users, systems, networks, or other entities. For example, reporting module 207 may generate and/or transmit one or more reports related to the automation opportunities. The reports may include data related to the automation opportunity/opportunities, risk factor data, risk inquiries, factor weights, scoring matrices, risk scores, performance data, validation data, ROI, or a combination thereof. In some embodiments, reporting module 207 may generate, based on the risk grade associated with an automation opportunity, a numerical representation of risk associated with the automation opportunity, a graphical representation of risk associated with the automation opportunity, a list of one or more mitigation options associated with the automation opportunity, a numerical representation of a comparison between the risk score and performance data, a graphical representation of a comparison between the risk score and performance data, or a combination thereof.

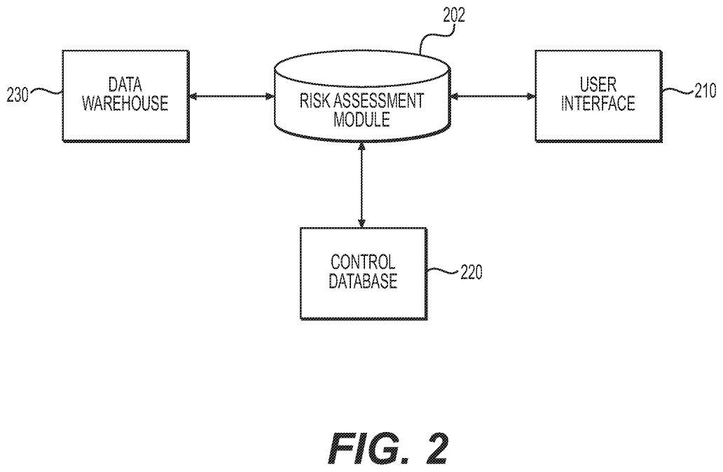

Referring to FIG. 2, risk assessment module 202 may be in communication with a user interface 210, a control database 220, and/or a data warehouse 230. A user may input an automation opportunity to risk assessment module 202 via user interface 210 (e.g., as part of intake system 101). For example, a list of risk inquiries may be transmitted to the user through user interface 210. In some embodiments, the list of risk inquiries is tailored to the specific automation opportunity presented. For example, risk assessment module 202 may determine which risk factors apply to the automation opportunity and, optionally, compile a series of risk inquiries to determine risk scores for the applicable risk factors. Each risk inquiry may correspond to one or more risk factors. In some embodiments, each risk inquiry corresponds to exactly one risk factor (e.g., only one). Additionally, the user may communicate risk factor data (e.g., responses to one or more risk inquiries) to risk assessment module 202 via user interface 210. As such, interface 210 may include any one or more input/output devices such as, for example, keyboard, mouse, display screen (e.g., touchscreen), trackpad, barcode scanner, monitor, printer, speaker, or similar suitable input/output device.

As users input one or more responses to one or more risk inquiries, the responses (e.g., risk factor data) may be stored in data warehouse 230. As risk scores are assigned to automation opportunities (e.g., based on risk factor data), those automation opportunities, risk scores, and associated risk factor data may be stored in data warehouse 230. As users input responses to one or more risk inquiries, user interface 210 may prompt the user with responses to a risk inquiry that were submitted to the same risk inquiry as applied to similar automation opportunities. In some embodiments, machine learning may be implemented to create a map of describing the similarity of automation opportunities.

Risk assessment module 202 may communication with control database 220 to determine if any regulations of a code of regulations and/or a ruleset may apply to the automation opportunity. A code of regulations may include, for example, governmental (or other regulatory body) regulations that dictate at least an aspect of one or more automation opportunities. A ruleset may correspond to a set of boundary conditions (e.g., rules) that limit or direct the scope of one or more automation opportunities. The ruleset may include one or more rules designed to limit or mitigate risk presented by an automation opportunity.

Risk assessment module 202 and/or control database 220 may determine (e.g., on the basis of received risk factor data) which rules and regulations apply to a given automation opportunity. Risk assessment module 202, upon receiving risk factor data, may communicate one or more rules or regulations (e.g., rules and regulations applicable to the automation opportunity) to the user via user interface 210. Based on the applicable rules and regulations, risk assessment module 202 and/or control database 220 may provide the user with a list of ways to mitigate or minimize the risk presented by the automation opportunity (via, e.g., user interface 210). In some embodiments, an automation opportunity may not be implemented until a user provides proof to risk assessment module 202 (e.g., via user interface 210) that the automation opportunity is compliant with the rules and/or regulations applicable to the automation opportunity.

The control database 220 may be regularly updated to include new and revised regulations and rules. In some embodiments, control database 220 and/or risk assessment module 202 may determine whether the code of regulations or ruleset has been modified within a specific window of time. Upon determining a modification has occurred, risk assessment module 202 may identify the modification to the code of regulations or ruleset and determine whether the modification to the code of regulations or ruleset affects a threshold amount of one or more risk factors. Risk assessment module 202 may communication with control database 220 and/or data warehouse 230 to determine whether the modification to the code of regulations or ruleset affects a threshold amount of risk factors. In some embodiments, a threshold amount of risk factors may be one risk factor, five risk factors, ten risk factors, or any other suitable number of risk factors. If a threshold amount of risk factors are affected, risk assessment module 202 and/or data warehouse 230 may adjust one or more risk factors.

In some embodiments, risk assessment module 202 may determine, calculate, or estimate a risk grade for an automation opportunity. For example, risk factor data related to one or more risk factors may be passed through (or compared to) a scoring matrix to generate a risk score for each risk factor of the one or more risk factors. For example, for certain automation opportunities, whether the automation opportunity utilizes associate-private information (API) and/or non-public information (NPI) may affect the risk presented by the automation opportunity. For such automation opportunities, risk assessment module 202 may transmit to a user (e.g., via user interface 210) an inquiry (e.g., a risk inquiry) as to whether the automation opportunity uses an API and/or NPI and the user may respond in the affirmative or the negative. The user's response (e.g., risk factor data) may be applied to a scoring matrix where an affirmative answer is translated to one risk point (or other arbitrary value) and a negative answer is translated to, for example, zero risk points. Therefore, in the above-described example, the risk score for the risk factor of whether an API or NPI will be implemented may be one or zero, as determined by the scoring matrix. Each risk factor may be associated with a unique scoring matrix. Additionally, for risk factors that are not binary (e.g., where more than two responses to the risk inquiry are possible), a scoring matrix may assign a wide variation of risk scores to the risk factor. Further exemplary risk inquires and scoring matrices associated with risk factors of various categories are described in Table 1 of the Examples section detailed below.

Risk assessment module 202 may use a model that describes the contributions of a plurality of risk factors as part of the overall risk presented by an automation opportunity to generate a risk grade based on the risk scores. For example, each risk factor may have an associated risk factor weight. The risk score for each risk factor may be multiplied by the associated risk factor weight and aggregated to determine a risk grade. Risk factors may be allocated into one or more categories, such as, for example, data-related risk, system-related risk, process-related risk, compliance-related risk, financial risk, or other risk. Each category may also have an associated category weight that represents the proportion of overall risk allocated to the category. Models used by risk assessment module 202 may include factor weights and category weights in the determination of a risk grade.

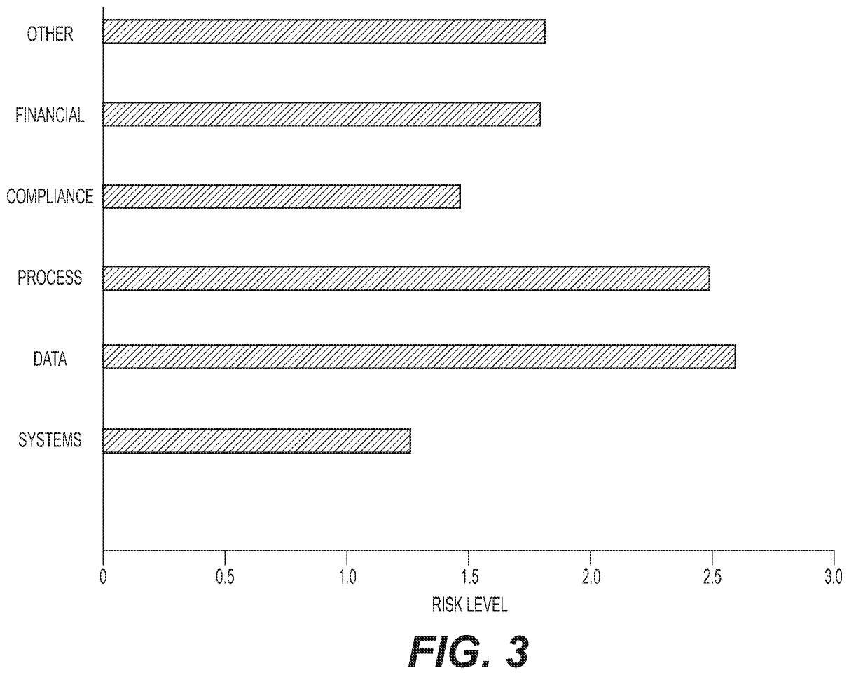

In some embodiments, based on the risk grade, a numerical representation of the risk associated with the automation opportunity, a graphical representation of the risk associated with the automation opportunity, or both may be generated. The numerical representation and/or graphical representation may represent the risk associated with the automation opportunity, as divided among a plurality of categories of risk. The graphical and/or numerical representations of risk may also include a list of one or more mitigation options, as determined by risk assessment module 202 and/or control database 220. One example of a graphical representation of risk associated with an automation opportunity, is shown in FIG. 3 and described in the Examples section detailed below.

In one or more embodiments, automation opportunities may be monitored, tracked, and/or assessed after implementation. As alluded to above, the performance of one or more automation opportunities may be tracked by the entity implementing the automation (e.g., by performance tracking system 102). In addition, or alternatively, the performance of one or more automation opportunities may be monitored by an outside entity (e.g., a third-party). The performance of the one or more automation opportunities may be compiled into third-party reports 103 and communicated to automation assessment system 200, as noted above.

The performance of automation opportunities may be periodically assessed (e.g., by periodic attestation module 205 and/or validation module 206). For example, the performance of an automation opportunity may be assessed every minute, every hour, every four hours, every twelve hours, daily, biweekly, weekly, semiweekly, monthly, every three months, biannually, or annually. Assessing the performance of an automation opportunity may include comparing the risk grade of the automation opportunity with the risk realized since the automation opportunity was implemented. Based on comparing the risk grade of an automation opportunity with the risk realized, it may be determined whether the risk grade for the automation opportunity was properly assigned, or if the variation from the projected risk deviates so far from expectations that an adjustment in the assessment methodology is needed. The determination of whether a risk grade for an automation opportunity was properly assigned may be assisted by leveraging data (e.g., automation opportunities, risk factor data, risk scores, risk grades, realized risks) contained within data warehouse 230.

Users with the requisite permissions may adjust risk factor data corresponding to the automation opportunity after implementation of the automation opportunity. In some embodiments, after the automation opportunity is implemented, risk factor data may be adjusted by risk assessment module 202. Other adjustments in the assessment methodology may be made, based on assessment of implemented automation opportunities. For example, one or more risk factors and/or their associated risk inquiries may be edited, added, or removed from the list of relevant risk factors for a given automation opportunity. Factor weights, category weights, and/or scoring matrices may also be adjusted based on the comparison of the performance data to the risk grade.

In general, the present disclosure provides systems and methods for assessing automation. While the disclosure includes descriptions of exemplary methods and systems, it will be understood that the steps of each method and the components of each system may be combined in various combinations or permutations and/or may be mixed and matched. For example, a step from one exemplary method may be used in conjunction with one or more steps of any exemplary method, a component (e.g., subsystem) of a exemplary system may be configured to interface with one or more components of any exemplary system, and any exemplary method may utilize any exemplary system.

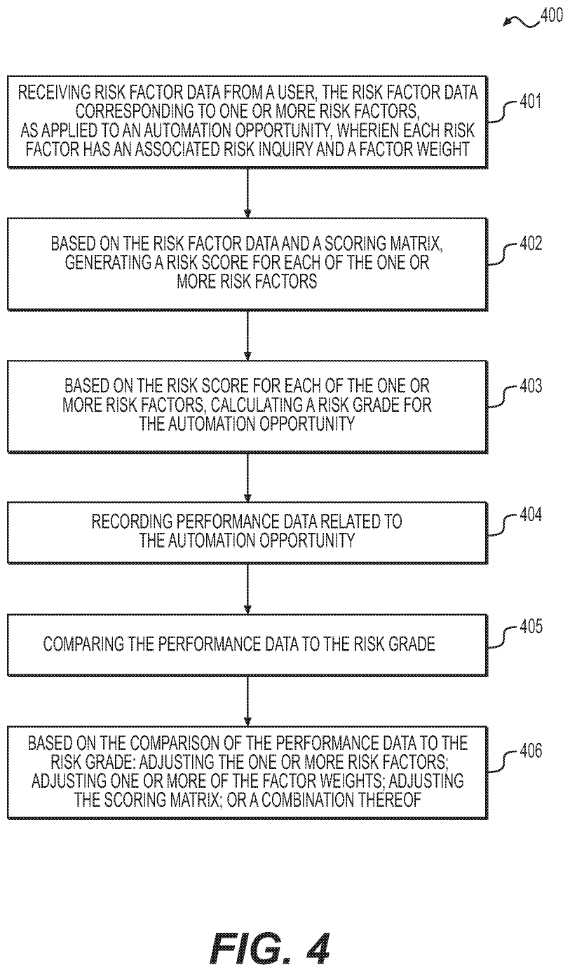

A method according to the present disclosure is illustrated in flow chart 400 of FIG. 4. The method may include receiving risk factor data from a user, the risk factor data corresponding to one or more risk factors, as applied to an automation opportunity, where each risk factor has an associated risk inquiry and a factor weight (Step 401). Next, the method may include generating a risk score for each of the one or more risk factors, based on the risk factor data and a scoring matrix (Step 402). Next, the method may include calculating a risk grade for the automation opportunity, based on the risk score for each of the one or more risk factors (Step 403). The method may further include recording performance data related to the automation opportunity (Step 404). In some embodiments, performance data may be recorded after the automation opportunity is implemented. Next, the method may include comparing the performance data to the risk grade (Step 405). In some embodiments, based on the comparison of the performance data to the risk grade, and/or determining that the risk grade was improperly assigned to the automation opportunity, one or more actions may be taken to adjust the risk assessment methodology. These actions may include adjusting the one or more risk factors, adjusting one or more of the factor weights, adjusting the scoring matrix, or a combination thereof (Step 406).

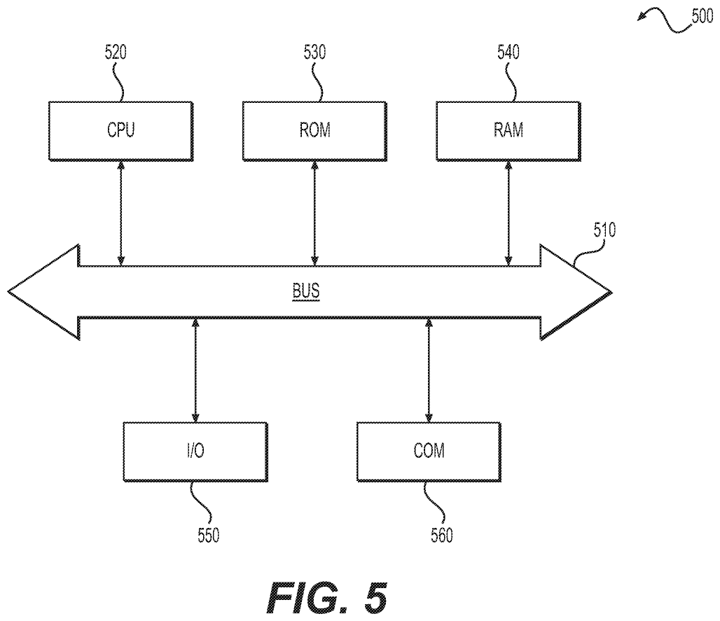

Various components of the system described herein may include one or more computing devices. As shown in FIG. 5, such devices 500 may include a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 may be connected to a data communication infrastructure 510, for example, a bus, message queue, network, or multi-core message-passing scheme.

Device 500 also may include a main memory 540, for example, random access memory (RAM), and also may include a secondary memory 530. Secondary memory 530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 530 may include other similar means for allowing computer programs or other instructions to be loaded into device 500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 500.

Device 500 also may include a communications interface (“COM”) 560. Communications interface 560 allows software and data to be transferred between device 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical, or other signals capable of being received by communications interface 560. These signals may be provided to communications interface 560 via a communications path of device 500, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 500 also may include input and output ports 550 to connect with input and output devices such as keyboards, mice, touchscreens, monitors, displays, etc. The various server functions may be implemented in a distributed fashion on a number of similar platforms, to distribute the processing load. Alternatively, the servers may be implemented by appropriate programming of one computer hardware platform.

### EXAMPLES

As described above, one or more exemplary methods may include transmitting risk inquiries related to an automation opportunity to users, receiving risk factor data corresponding to one or more risk factors as applied to the automation opportunity, generating a risk factor score for each risk factor, calculating the risk grade for the automation opportunity, and generating a numerical representation and/or a graphical representation of the risk associated with the automation opportunity. An exemplary listing of risk inquiries and scoring matrices are described below, in Table 1. As described previously, each risk factor may be allocated into a category of risk. An exemplary allocation of category is included accompanying the description of risk inquiries and scoring matrices. However, the category allocation is only one such exemplary allocation of the risk factors described in Table 1.

TABLE 1
Exemplary Risk Inquiries with Scoring
Matrices and Category Allocations

| | Scoring Matrix | | |
|---|---|---|---|
| | Qualifying | Risk | |
| Risk Inquiry | Risk Factor Data | Score | Category |
| Does the automation | Yes | 0 | System |
| opportunity utilize an | No | 1 | |
| application? | | | |
| How many different | 0 | 0 | System |
| systems are leveraged as | 1-2 | 1 | |
| part of the automation | 3+ | 2 | |
| opportunity? | | | |
| What type of software is | Proprietary | 0 | System |
| being used? | Public | 1 | |
| | Open Source | 2 | |
| Will the automation | No log-in | 0 | System |
| opportunity require log-in | System-wide | 1 | |
| credentials? What type? | log-in | | |
| | User-specific | 2 | |
| | log-in | | |
| Was the automation | Hybrid | 0 | System |
| opportunity developed by a | Technology | 1 | |
| business team or a | Business | 2 | |
| technology team? | | | |
| Will the automation | Yes | 0 | Data |
| opportunity utilize NPI or API? | No | 1 | |
| How many data sources is | 0-1 | 0 | Data |
| the automation opportunity | 2-3 | 1 | |
| dependent on? | 4+ | 2 | |
| How severe are the | Low | 0 | Process |
| consequences of failure of | Medium | 1 | |
| the automation opportunity? | High | 2 | |
| How complex was the | Low | 0 | Process |
| process being displaced by | Medium | 1 | |
| the automation opportunity? | High | 2 | |
| How complex is the | Low | 0 | Process |
| automation opportunity? | Medium | 1 | |
| | High | 2 | |
| How many downstream | 0 | 0 | Process |
| processes are dependent on | 1-2 | 1 | |
| the automation opportunity? | 3+ | 2 | |
| Does the automation | No | 0 | Process |
| opportunity overlap with a | Yes | 1 | |
| critical business process? | | | |
| How frequently will the | Monthly | 0 | Process |
| automation opportunity | Daily to Weekly | 1 | |
| operate? | Constant | 2 | |
| Does the automation | No | 0 | Compliance |
| opportunity overlap with a | Yes | 1 | |
| compliance-related process? | | | |
| Is the automation | No | 0 | Compliance |
| opportunity related to high | Yes | 1 | |
| impact regulations (e.g., | | | |
| anti-money laundering, | | | |
| privacy regulations)? | | | |
| What are the financial | Less than | 0 | Financial |
| implications? | 200,000 USD | | |
| | 200,000 USD to | 1 | |
| | 999,999 USD | | |
| | More than | 2 | |
| | 1 million USD | | |
| Does the automation | No | 0 | Financial |
| opportunity affect the fraud | Yes | 1 | |
| management position of the | | | |
| implementing organization? | | | |
| Would failure of the | No | 0 | Other |
| automation opportunity | Yes | 1 | |
| affect the experience of a | | | |
| customer? | | | |
| Does the automation | No | 0 | Other |
| opportunity input data from | Yes | 1 | |
| or output data to an | | | |
| existing model? | | | |
| Does the automation | No | 0 | Other |
| opportunity interact with | Yes | 1 | |
| third-parties? | | | |
| Will associate labor be | No | 0 | Other |
| displaced? | minimal | 1 | |
| | displacement | | |
| | moderate or | 2 | |
| | extreme | | |
| | displacement | | |

In response to receiving an automation opportunity (e.g., from intake system 101), a risk assessment module (e.g., risk assessment module 202) may determine that one or more of the above listed risk inquiries may be appropriate. The appropriate risk inquiries may be transmitted to a user, e.g., via user interface 210. The user may respond with, for example, risk factor data, and the risk factor data may be applied through the scoring matrix. For example, one risk factor for an automation opportunity is whether the automation opportunity inputs data from or outputs data to an existing model, process, or system. Based on risk factor data that indicates the automation opportunity inputs data to an existing model, risk assessment module 202 may assign a risk score of 1 for that risk factor, according to the scoring matrix shown in Table 1.

Some risk factors, such as, for example, the complexity of the process being replaced by the automation opportunity, are not readily quantifiable. Risk inquiries associated with such risk factors may ask for a more qualitative determination. Such risk inquiries may also include suggestions based on responses from similar automation opportunities, as described previously.

As described above, each risk factor may have an associated factor weight. Further each risk factor may be allocated into categories, and each category may have an associated category weight. For each risk factor, the risk score is multiplied by the factor weight. The sum of all risk scores in a category may represent the risk associated with that category of risk (e.g., a category risk). Each sum may then be multiplied by the associated category weight and those products may be summed to determine a risk grade.

FIG. 3 depicts an exemplary graphical representation of the risk associated with an automation opportunity. An example automation opportunity was assessed via the risk inquiries listed in Table 1. The risk factors were grouped into six categories, data-related risk, system-related risk, process-related risk, compliance-related risk, financial risk, and other risk. Exemplary risk factor data was converted via the scoring matrix listed in Table 1 to calculate risk scores for each risk factor. The risk scores were multiplied by factor weights and summed by category, as allocated in Table 1, to calculate the associated category scores shown in FIG. 3.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

1. A computer-implemented method for assessing automation at a system for implementing an automation opportunity, the method comprising:
receiving, at the system, input data from a user device of the automation opportunity;
determining a list of risk factors applicable to the automation opportunity based on the input data;
determining a code of regulations and a ruleset based on the list of risk factors determined to be applicable to the automation opportunity;
receiving risk factor data on the system from the user device, the risk factor data corresponding to one or more risk factors, as applied to the automation opportunity, wherein each risk factor has an associated risk inquiry and a factor weight;
transmitting one or more risk inquiries associated with the automation opportunity and one or more mitigation options associated with the automation opportunity from the system to the user device;
based on the risk factor data and a scoring matrix, generating a risk score for each of the one or more risk factors;
based on the risk score for each of the one or more risk factors, calculating a risk grade for the automation opportunity;
performing the automation opportunity to record performance data related to the automation opportunity on the system;
comparing the performance data to the risk grade to determine a variance between the list of risk factors associated with the automation opportunity in the system and performance of the automation opportunity;
based on determining the variance from the comparison of the performance data to the risk grade:
adjusting the one or more risk factors;
adjusting one or more of the factor weights;
adjusting the scoring matrix; or
a combination thereof to modify the automation opportunity stored in the system, and
inhibiting implementation of the automation opportunity when the adjustments to the risk factors, the factor weights, or the scoring matrix are noncompliant with the code of regulations and the ruleset, wherein the system is configured to allow implementation of the automation opportunity when in compliance with the code of regulations and the ruleset.

2. The method of claim 1, further comprising:
generating, based on the risk grade, a numerical representation of a risk associated with the automation opportunity, a graphical representation of the risk associated with the automation opportunity, a list of one or more mitigation options associated with the automation opportunity, or a combination thereof.

3. The method of claim 1, further comprising communicating the risk score to the user device.

4. The method of claim 1, wherein each risk factor of the list of risk factors has an associated category.

5. The method of claim 1, wherein the method includes the adjusting the one or more risk factors, and wherein the adjusting the one or more risk factors includes editing the risk inquiry associated with the risk factor.

6. The method of claim 1, wherein the code of regulations and the ruleset are revised periodically.

7. The method of claim 1, further comprising:
determining whether the code of regulations or ruleset has been modified within a specified period of time;
upon determining that a modification has occurred, identifying the modification to the code of regulations or ruleset; and
determining whether the modification to the code of regulations or ruleset affects a threshold amount of the one or more risk factors.

8. The method of claim 7, further comprising:
based on the determining whether the modification to the code of regulations or ruleset affects the threshold amount of the one or more risk factors:
adjusting the one or more risk factors;
adjusting one or more of the factor weights;
adjusting the scoring matrix; or
a combination thereof.

9. The method of claim 1, wherein the automation opportunity is a first automation opportunity, the method further comprising:
comparing the first automation opportunity to one or more additional automation opportunities; and
conveying the comparison of the first automation opportunity to the one or more additional automation opportunities to the user.

10. A computer system for assessing automation and implementing an automation opportunity, the computer system comprising:
a memory storing instructions; and
one or more processors configured to execute the instructions to perform operations, the operations including:
transmitting one or more risk inquiries to a user device in response to receiving input data of the automation opportunity from the user device;
receiving a response to the one or more risk inquiries from the user device, the response including risk factor data, the risk factor data corresponding to one or more risk factors, as applied to the automation opportunity, wherein each risk factor has a factor weight;
after receiving the response to the one or more risk inquiries, transmitting one or more mitigation options associated with the automation opportunity to the user device;
based on the risk factor data and a scoring matrix, generating a risk score for each of the one or more risk factors;
based on the risk scores and the factor weights, determining a plurality of category scores;
based on the plurality of category scores, determining a risk grade for the automation opportunity;
performing the automation opportunity to record performance data related to the automation opportunity;
comparing the performance data to the risk grade to determine a variance between the list of risk factors associated with the automation opportunity and performance of the automation opportunity;
based on determining the variance from the comparison of the performance data to the risk grade:
adjusting the one or more risk factors;
adjusting one or more of the factor weights;
adjusting the scoring matrix; or
a combination thereof to modify the automation opportunity stored in the system; and
allowing implementation of the automation opportunity when the adjustments to the risk factors, the factor weights, or the scoring matrix indicate the automation opportunity is in compliance with a code of regulations and a ruleset.

11. The system of claim 10, wherein a number of risk inquiries is equal to a number of risk factors.

12. The system of claim 10, wherein
each risk factor of the one or more risk factors is assigned to one of a plurality of categories, with each category having a category weight; and
the determining the risk grade includes determining the risk grade based on the category weights.

13. The system of claim 10, wherein the one or more risk factors are determined from a database comprising the code of regulations and the ruleset, and the operations further include:
identifying any modifications to the code of regulations or ruleset;
determining whether the modification to the code of regulations or ruleset affects a threshold amount of risk factors.

14. The system of claim 13, wherein the operations further include, if a modification is determined to affect a threshold amount of risk factors:
adjusting one or more risk factors;
adjusting one or more factor weights;
adjusting the scoring matrix; or
a combination thereof.

15. The system of claim 10, wherein the operations further include generating, based on the risk grade, a numerical representation of a risk associated with the automation opportunity, a graphical representation of the risk associated with the automation opportunity, a list of one or more mitigation options associated with the automation opportunity, or a combination thereof.

16. The system of claim 15, wherein the operations further include communicating a graphical representation of the risk associated with the automation opportunity, a list of one or more mitigation options associated with the automation opportunity, or both, to the user device.

17. The system of claim 10, wherein the operations further include communicating the risk score to the user device.

18. The system of claim 10, wherein the operations further include comparing the risk grade of the automation opportunity with one or more calculated risk grades of one or more other automation opportunities.

19. The system of claim 10, wherein the automation opportunity is a first automation opportunity, and the operations further comprise:
comparing the first automation opportunity to one or more additional automation opportunities; and
based on the comparison of the first automation opportunity to one or more additional automation opportunities:
adjusting one or more risk factors;
adjusting one or more factor weights;
adjusting the scoring matrix;
communicating a list of mitigation options associated with the first automation opportunity to the user; or
a combination thereof.

20. A non-transitory computer-readable medium storing instructions that, when executed by one or more processors of a computer system, cause the one or more processors to perform operations comprising:
receiving input data of an automation opportunity from a user device, wherein the automation opportunity is stored in the computer system;
determining a preliminary list of risk factors applicable to the automation opportunity based on the input data, wherein the preliminary list of risk factors includes factors associated with the automation opportunity in the computer system;
determining a code of regulations and a ruleset applicable to the automation opportunity based on the preliminary list of risk factors determined to be applicable to the automation opportunity;
transmitting one or more risk inquiries associated with the automation opportunity to the user device;
receiving a response to the one or more risk inquiries from the user device, wherein the response includes risk factor data, the risk factor data corresponding to one or more risk factors, wherein each risk factor has a factor weight;
based on the response to one or more risk inquiries from the user device, transmitting one or more mitigation options associated with the automation opportunity to the user device;
based on the risk factor data and a scoring matrix, generating a risk score for each of the one or more risk factors;
based on the risk score for each of the one or more risk factors, calculating a risk grade for the automation opportunity;
transmitting the risk grade to the user device;
performing the automation opportunity to record performance data related to the automation opportunity;
comparing the performance data to the risk grade to determine a variance between the preliminary list of risk factors and performance of the automation opportunity; and
based on determining the variance from the comparison of the performance data to the risk grade, modifying the preliminary list of risk of factors associated with the automation opportunity by:
adjusting the one or more risk factors;
adjusting one or more of the factor weights;
adjusting the scoring matrix; or
a combination thereof to associate a modified list of risk factors with the automation opportunity stored in the computer system; and
comparing the modified list of risk factors with the code of regulations and the ruleset to determine compliance, wherein the system is configured to store the automation opportunity for implementation when in compliance with the code of regulations and the ruleset, and to inhibit storage of the automation opportunity when noncompliant with the code of regulations and the ruleset.
